(19) United States
(12) Patent Application Publication
(10) Pub. No.: US 2003/0063800 A1
(43) Pub. Date: Apr. 3, 2003

(54) Image processing method for deleting background from picture in digital image representation

(75) Inventor: Car-Lai Ma, Taipei (TW)

Correspondence Address: BACON & THOMAS, PLLC, 625 SLATERS LANE, FOURTH FLOOR, ALEXANDRIA, VA, 22314

(73) Assignee: Tiger Color Inc., Taipei (TW)

(21) Appl. No.: 09/968,789

(22) Filed: Oct. 3, 2001

(51) Int. Cl. G06K 9/34; G06K 9/20; G06K 9/36

(52) U.S. Cl. 382/173; 382/282

(57) ABSTRACT

A method for processing a digital image representation shown on a computer comprising the steps of memorizing each one of a plurality of sections of a cutting line drawn by a cutting object in the digital image representation along the contour of a picture, activating a restore function when an error occurred in the previous section for undoing the erroneous section, thereby restoring the cutting line drawn along the contour of the picture to a correct one which is served as a new beginning of drawing the cutting line.

### FIELD OF THE INVENTION

The present invention relates to image processing and more particularly to an improved image processing method for deleting background from picture in digital image representation.

### BACKGROUND OF THE INVENTION

Electronic technologies have known a rapid and a spectacular development leading to an increasing performance of computers and peripherals thereof. Further, a variety of inexpensive software are continuously available. This in turn makes computers and peripherals more popular among consumers for facilitating daily life, learning, and so on. For taking advantage of such trend, many AV product manufacturers endeavor to develop digitized products for attracting the newly formed many computer consumers. For example, in the case of digital camera, manufacturers usually give free image processing software when user buys a digital camera, thereby attracting more consumers to buy their products. By utilizing the image processing software, user may read the fetched digital image representation from digital camera and show the same from screen of a connected computer or TV. Alternatively, user may edit image therein. This has the benefits of saving cost of printing photographs, customizing digital image representation, saving storage space and related resources, and so forth.

It is typical for the commercially available image processing software having the capability of editing and modifying digital image representation. However, such features do not allow user to quickly edit and modify background of picture in the taken digital image representation. In a typical case, a conventional image processing software has the capability of editing and modifying a picture. That is, user may open a digital image representation and show the same on computer by performing image processing software. In addition, user may select a desired option from tool box provided by the image processing software, thereby editing and modifying picture in the digital image representation.

Conventionally, for preserving a picture in digital image representation, user can select a cut object from tool box. Then slowly cuts the picture along its contour shown on screen by dragging a mouse. Eventually, a complete picture is cut out from digital image representation. However, it is typical for picture having an irregular contour. Hence, in cutting the picture user tends to cut undesired portion thereof due to careless or unskillful mouse operation (e.g., vibration of hand). In response, conventionally, user has to delete all contents drawn along contour of picture shown on screen by performing a restore mechanism available from the image processing software prior to doing the cutting along contour of picture from the beginning again. Such procedure in undoing one mistake in cutting the picture in digital image representation greatly frustrates user. Moreover, such repeated restoration and cutting operations greatly reduce the efficiency of editing and modifying picture by the image processing software. In view of above, there is a need to improve the existing image processing software.

### SUMMARY OF THE INVENTION

The present invention is directed to solve the problems associated with the prior art as stated in the background section of the specification. In brief, user has to delete all contents drawn along contour of picture shown on screen by performing a restore mechanism available from one of existing a variety of image processing software even if only a portion of the contents is undesired irrespective of whether such undesired portion is done intentionally or not. Thereafter, user has to do the cutting along contour of picture from the beginning again.

It is therefore an object of the present invention to provide a method for processing a digital image representation shown on a computer comprising the steps of a) memorizing each one of a plurality of sections of a cutting line drawn in the digital image representation along the contour of a picture; b) activating a restore function when an error occurred in the previous section for undoing the erroneous section, thereby restoring the cutting line drawn along the contour of the picture to a correct one which is served as a new beginning of drawing the cutting line; c) cutting the picture from the digital image representation in response to a closed loop formed by the cutting line drawn along the contour of the picture; and d) deleting a background outside the picture in the digital image representation. By utilizing the method of the invention, it is possible of quickly cutting a complete picture from the digital image representation.

In one aspect of the present invention once the picture is cut from the digital image representation, an erase object is operable to delete the background outside an area enclosed by the contour of the picture so as to leave the picture only.

In another aspect of the present invention, a background object is operable to allow the image processing software to paste a second digital image representation under the picture for serving the background thereof. In such a manner, user may change background of picture as needed or preference. As a result, user can quickly compose a desired digital image representation on screen.

The above and other objects, features and advantages of the present invention will become apparent from the following detailed description taken with the accompanying drawings.

### BRIEF DESCRIPTION OF THE DRAWINGS

FIG. 1 illustrates a screen display of a digital image representation, showing a background to be deleted from the picture in digital image representation by clicking an appropriate one of buttons according to a preferred embodiment of the invention;

FIG. 2 is an enlarged view of the digital image representation of FIG. 1;

FIG. 3 illustrates a screen display of the digital image representation of FIG. 2, showing a cutting being done along contour of a picture therein

FIG. 4 is a view similar to FIG. 3 where an erroneous cutting is shown;

FIG. 5 is a view similar to FIG. 4 where the erroneous cutting is undone for restoring to a correct one;

FIG. 6 illustrates a screen display of the digital image representation of FIG. 2, where a cutting is done along contour of the picture therein;

FIG. 7 illustrates a screen display of the digital image representation of FIG. 1, where background is deleted therefrom;

FIG. 8 illustrates a screen display of the digital image representation of FIG. 1, where a new picture is shown by composing new background thereto; and

FIG. 9 is a flow chart illustrating how to delete background from picture in digital image representation by a method according to the invention.

### DETAILED DESCRIPTION OF THE PREFERRED EMBODIMENTS

As for any one of existing image processing software in modifying or composing a picture in digital image representation, the most difficult job is to delete unwanted background of the picture. This is because, in general, the picture to be remained has an irregular contour. And in turn, in cutting the picture user tends to cut undesired portion thereof due to careless or unskillful mouse operation (e.g., vibration of hand). In response, conventionally, user has to delete all contents drawn along contour of picture shown on screen by performing a restore mechanism available from the image processing software prior to doing the cutting along contour of picture from the beginning again. Such repeated restoration and cutting operations greatly reduce the efficiency of digital image representation modification or composition by the image processing software.

In solving above problem encountered by the conventional image processing software in deleting background from a picture of digital image representation, an image processing method for deleting background from picture in digital image representation is provided by the invention. The method comprises the steps of a) memorizing each one of a plurality of sections of a cutting line drawn in the digital image representation along the contour of a picture; b) activating a restore function when an error occurred in the previous section for undoing the erroneous section, thereby restoring the cutting line drawn along the contour of the picture to a correct one which is served as a new beginning of drawing the cutting line; c) cutting the picture from the digital image representation in response to a closed loop formed by the cutting line drawn along the contour of the picture; and d) deleting a background outside the picture in the digital image representation.

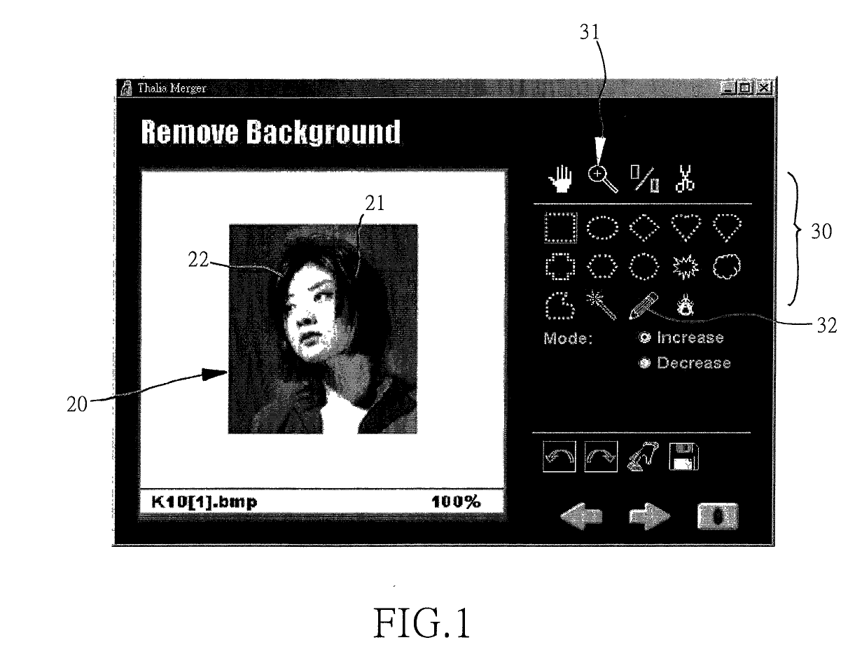

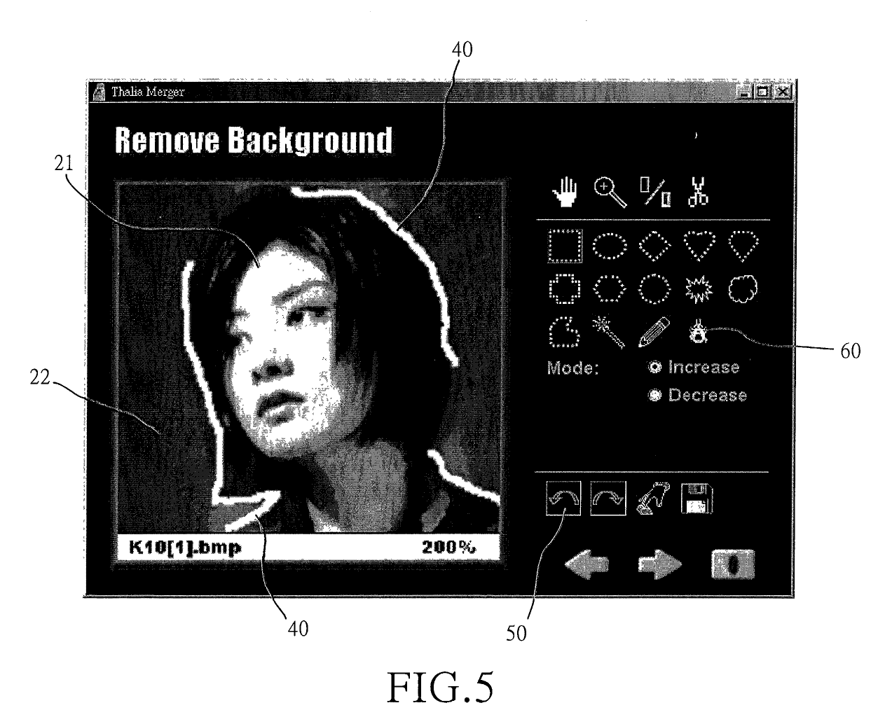

Referring to FIGS. 1 to 8, there is illustrated an image processing method for deleting background from picture in digital image representation in accordance with a preferred embodiment of the invention. First, user may use a background deletion button (of a plurality of option buttons provided by an image processing software installed in a computer) on screen for reading digital image representation 20. The read out digital image representation 20 is shown on screen in which a background is to be cut from digital image representation 20 (FIG. 1). Then user may select a desired icon (e.g., enlarge, cut, move, or any of others) from a tool box 30 provided by image processing software for modifying the digital image representation 20.

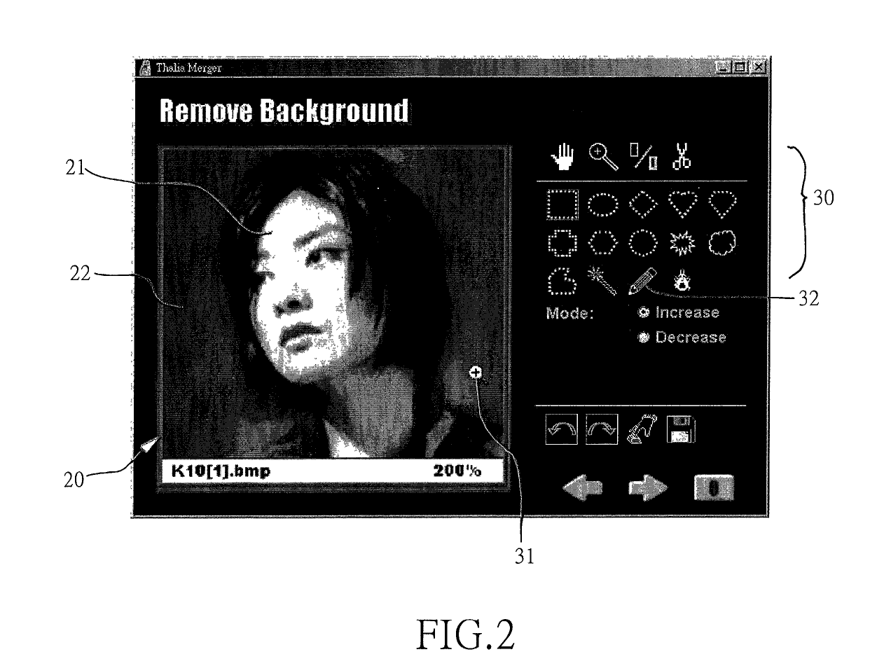

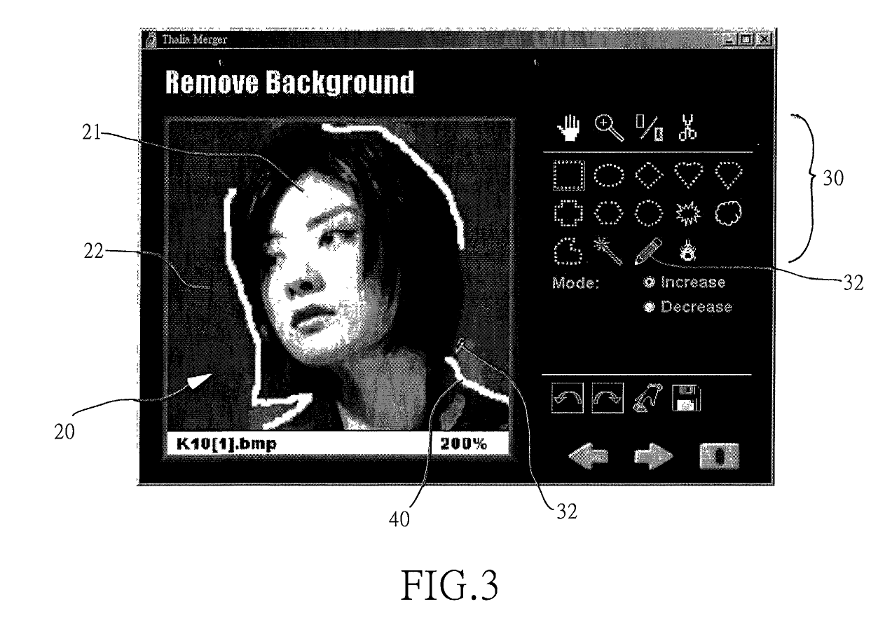

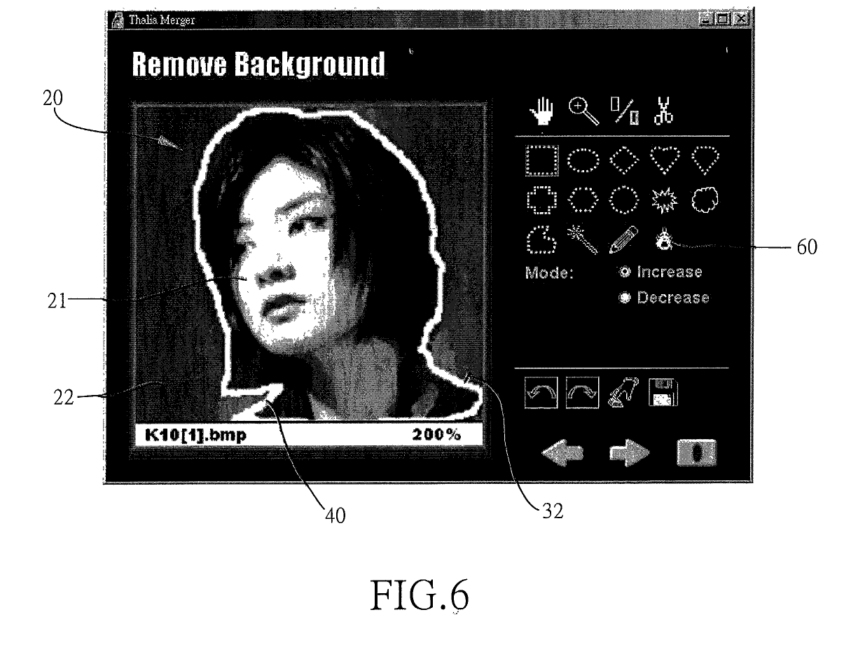

In the embodiment, user my first select an enlarge icon 31 from tool box 30. As shown in FIG. 2, user may enlarge a picture 21 (e.g., portrait of a woman as shown) in digital image representation 20 in order to delete background 22 therefrom later. In FIG. 3, the contour of picture 21 is clearly seen on background 22. Then, select a cut icon 32 from tool box 30. As shown, cut icon 32 is a white pen. But it may be replaced by another suitable icon in any of other embodiments. User may manipulate the white pen to draw a white line 40 along contour of picture 21 by using mouse or any of other input devices (e.g., sensor pen of a digitizer). As shown in FIG. 6, once an enclosed white line 40 (i.e., closed loop) is formed, image processing software may delete background 22 from picture 21 thereafter.

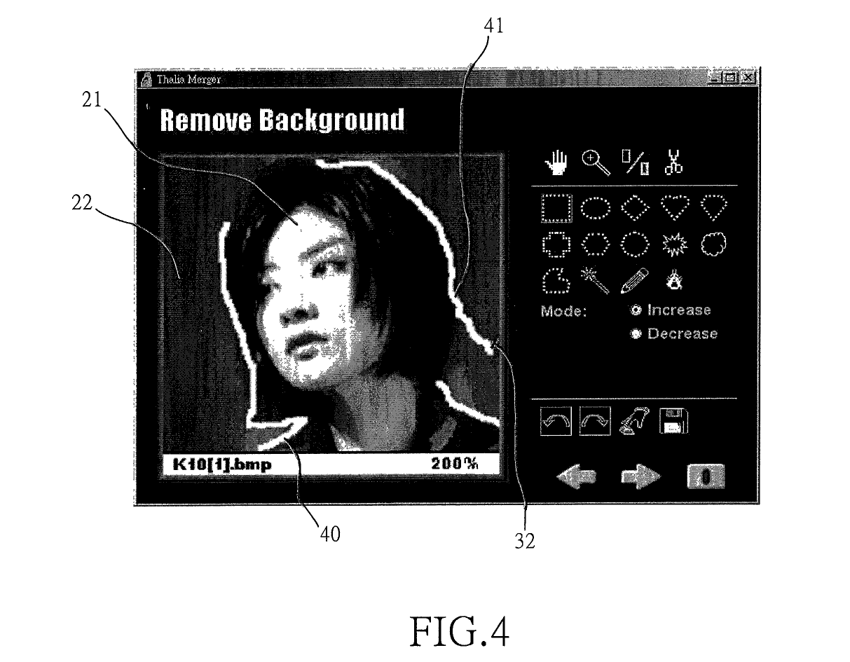

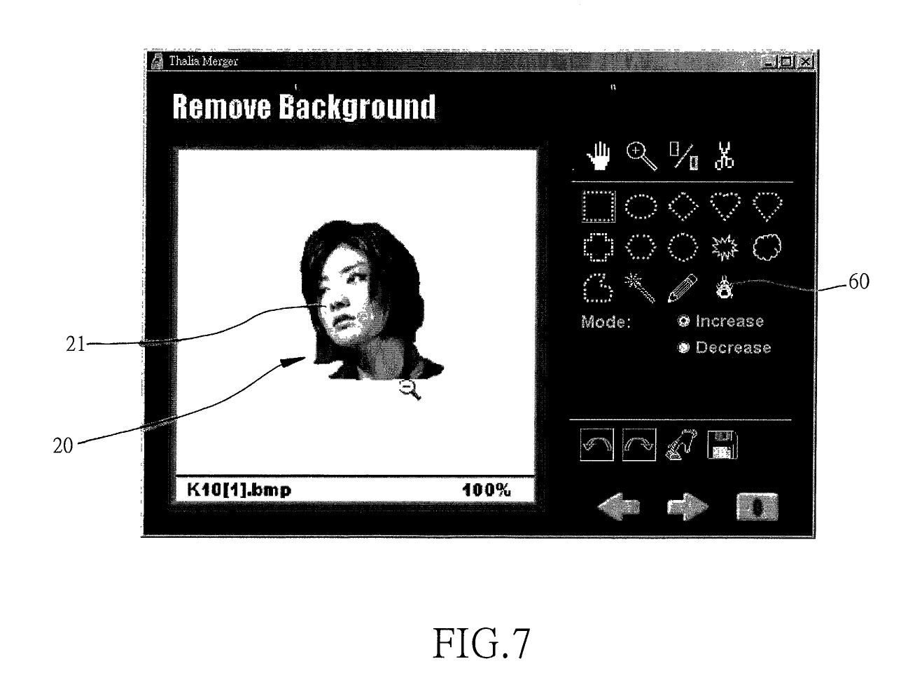

In the embodiment, user desires to cut background 22 from picture 21 (to be remained) in digital image representation 20. As shown, picture 21 has an irregular contour. Hence, in cutting the picture 21 user tends to cut undesired portion thereof due to careless or unskillful mouse operation (e.g., vibration of hand) as shown in FIG. 4. For undoing above erroneous operation, image processing software may mark each section of white line 40 drawn by white pen 32 based on length of white line 40 or execution time of the drawing operation. Thus, image processing software may memorize each of a plurality of sections of white line 40 forming a path along the contour of picture 21. Further, user may click on restore button 50 available from image processing software for deleting the erroneous section of white line 40 (i.e., return to the end point of the last correct section of white line 40) only without deleting all of the already drawn white line 40. In brief, by utilizing the method of the invention, whenever an error occurred in a previous operation it is possible of restoring the drawn contour of picture 21 to a correct one served as a new beginning of drawing the white line by simply undoing the erroneous portion. In such a manner, eventually a complete picture 21 is cut out from digital image representation 20. After white pen 32 has drawn a complete contour of picture 21, it is possible of cutting picture 21 out of digital image representation 20 (FIG. 6). Next, user may select an erase object 60 available from image processing software for deleting background 22 (at outside of the area enclosed by white line 40) from picture 21 in digital image representation 20. As a result, only picture 21 is remained (FIG. 7).

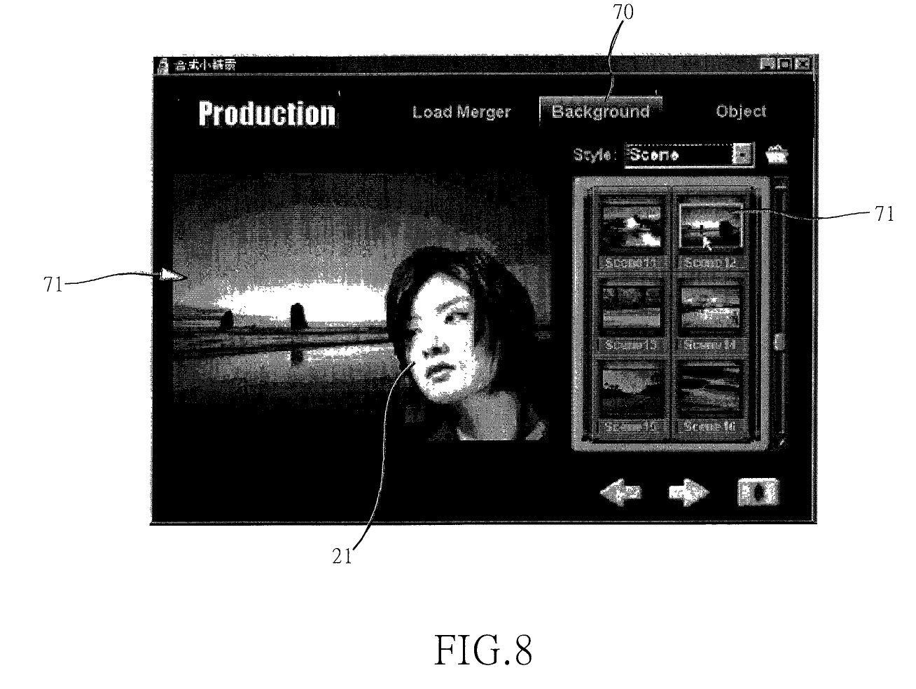

Referring to FIG. 8 specifically, an image composition on the picture 21 without background 22 will now be described. First, user selects a background object 70 available from image processing software. Next, image processing software may paste another digital image representation 71 under picture 21 by double clicking the digital image representation 71 being selected. Therefore, the another digital image representation 71 becomes a new background of picture 21. In such a manner, user may change background of picture as needed or preference. As a result, user can quickly compose a desired digital image representation on screen.

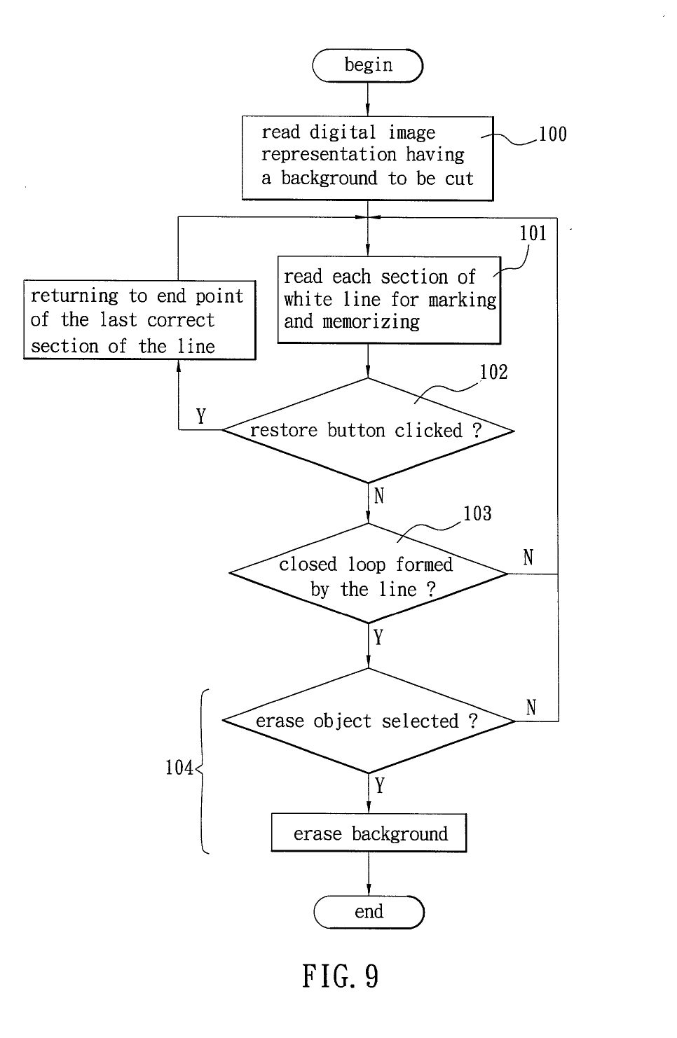

Referring to FIG. 9, there is shown a flow chart illustrating how to delete background from picture in digital image representation by a method according to the invention. The method comprises the following steps:

In step 100, first read digital image representation 20 having a background to be cut therefrom by clicking a background deletion button. The read out digital image representation 20 is shown on screen.

In step 101, read each section of white line 40 drawn by a white pen 32 along contour of picture 21. Further, mark each section based on length of white line 40 or execution time of the drawing operation. Thus, image processing software may memorize each of a plurality of sections of white line 40 forming a path along the contour of picture 21.

In step 102, a determination is made as to whether a restore button is clicked (i.e., determining whether a trigger signal is received from the clicked restore button). If yes, process loops back to step 101 via a step of returning to the end point of the last correct section of white line 40. Otherwise, process goes to step 103.

In step 103, a determination is made as to whether an enclosed white line 40 (i.e., enclosed loop) is formed. If yes, process goes to step 104. Otherwise, process loops back to step 101.

In step 104, a determination is made as to whether an erase object is selected. If yes, process goes on to erase background 22 (at outside of the area enclosed by white line 40) from picture 21 in digital image representation 20, resulting in a remained picture 21. Otherwise, process loops back to step 101.

By doing this, user may cut picture from digital image representation. Further, user can change background of picture as needed or preference. As a result, user may quickly compose a desired digital image representation on screen.

While the invention has been described by means of specific embodiments, numerous modifications and variations could be made thereto by those skilled in the art without departing from the scope and spirit of the invention set forth in the claims.

What is claimed is:

1. A method for processing a digital image representation shown on a computer comprising the steps of:
memorizing each one of a plurality of sections of a cutting line drawn in the digital image representation along the contour of a picture;
restoring the cutting line drawn along the contour of the picture to a correct one, which is served as a new beginning of drawing the cutting line, when a restore function being activated during an error occurred in the previous section for undoing the erroneous section.

2. The method of claim 1, wherein the image processing software comprises a tool box having a cutting object which is operable to draw a cutting line on the screen along the contour of the picture via input means electrically coupled to the computer.

3. The method of claim 2, wherein in drawing the cutting line on the screen along the contour of the picture the image processing software marks each one of the plurality of sections of the line based on a length of the line so as to memorize each one of the plurality of sections of the line forming the path along the contour of the picture.

4. The method of claim 2, wherein in drawing the cutting line on the screen along the contour of the picture the image processing software marks each section of the line based on an execution time of the drawing operation so as to memorize each one of the plurality of sections of the line forming the path along the contour of the picture.

5. The method of claim 2 wherein the tool box further comprises a restore button which is operable to restore the cutting line drawn along the contour of the picture to a correct one.

6. The method of claim 5, wherein the tool box further comprises an erase object which is operable to erase the background outside the area enclosed by the cutting line.

7. The method of claim 6, wherein the image processing software further comprises a background object which is operable to allow the image processing software to paste a second digital image representation under the picture for serving as the background thereof.

8. The method of claim 7, wherein in deleting the background from the picture in the digital image representation the computer performs the steps of:
reading the digital image representation having a background to be cut;
marking each one of the plurality of sections of the cutting line drawn by cutting object so as to memorize each one of the plurality of sections of the cutting line forming the path along the contour of the picture;
determining whether a trigger signal is received from the clicked restore button; and
returning to the end point of the last correct section of the cutting line, if there is a trigger signal received from the clicked restore button.

9. The method of claim 8, wherein if there isn't any trigger signal received from the clicked restore button, the method further comprising the steps of:
determining whether a closed loop is formed by the cutting line;
determining whether the erase object is activated, if a closed loop is formed by the cutting line;
deleting the background outside the closed loop, if the erase object is activated.
